(19) United States
(12) Patent Application Publication
(10) Pub. No.: US 2019/0277243 A1
(43) Pub. Date: Sep. 12, 2019

(54) GENERATOR DEVICE

(71) Applicants: TE-LU TSENG, NEW TAIPEI CITY (TW); CHIH-SHIANG TSENG, SAN JOSE, CA (US)

(72) Inventor: TE-LU TSENG, NEW TAIPEI CITY, (TW)

(21) Appl. No.: 16/347,475

(22) PCT Filed: Nov. 7, 2017
(86) PCT No.: PCT/US2017/060280

§ 371 Date: May 3, 2019

(30) Foreign Application Priority Data
Nov. 8, 2016 (TW) 105136275
Nov. 8, 2016 (TW) 105217037
Nov. 15, 2016 (TW) 105137266
Nov. 15, 2016 (TW) 105217400
Nov. 25, 2016 (TW) 105218037
Apr. 18, 2017 (TW) 106112863
Apr. 18, 2017 (TW) 106205368

(51) Int. Cl. F03B 13/10; F16H 1/22; F03D 3/04; F03D 15/00; F03D 9/25; F03B 11/02; F03B 17/06; H02K 7/116; H02K 7/18

(52) U.S. Cl. CPC F03B 13/10; F16H 1/22; F03D 3/04; F03D 15/00; H02K 7/1823; F03B 11/02; F03B 17/062; H02K 7/116; F03D 9/25

(57) ABSTRACT

A generator device includes a fluid confluent guide device including guiding plates and a housing having an inlet, a curved member, and a transverse channel as an outlet; and a wheel including two spaced rims having teeth, and blades between the rims. The electric turbine generator converts the energy of flowing water (e.g., sea water) or wind into useful forms of power. Fluid entering a space between the two adjacent guiding plates is divided into rotating fluid portions. The fluid strikes the blades in an optimum angle. The wheel without axle works well with decreased fluid velocity. The electricity generating devices are driven by the wheel. Total electricity generation is borne by the electricity generating devices. A single electricity generating device has a relatively small weight. This can lower the risk of installation. Locations having a lower fluid velocity can be selected for installing the electric turbine generator.

### BACKGROUND OF THE INVENTION

### 1. Field of the Invention

The invention relates to generator device and more particularly to an electric turbine generator. The electric turbine generator is capable of converting the energy of flowing water (e.g., sea water) or wind into useful forms of power. The electric turbine generator comprises a fluid confluent guide device, a wheel and a plurality of electricity generating devices. The fluid confluent guide device can increase fluid velocity and divide fluid entering a space between the two adjacent guiding plates into rotating fluid portions. The fluid strikes the blades in an optimum angle. The electricity generating devices are driven by the wheel. Total electricity generation is borne by a plurality of the electricity generating devices. A single electricity generating device has a relatively small weight. It can rotate in high speed. It lowers the risk of installation.

### 2. Description of Related Art

Conventional tidal stream generators function very much like wind turbines and are thus often referred to as tidal turbines. However, the conventional tidal stream generators have the following drawbacks: It is not stable if it floats on the sea. Construction is difficult and risky if it is secured to the sea bottom. Only one electric generator is provided. Sea flow directly strikes the blades for rotation and this is disadvantageous due to small blade diameter, small fluid striking area of the blade, and low power generation. Installation of distribution lines across the sea bottom is difficult. Power generation cost is very high. Installation of the tidal stream generator is risky.

According to a publication “Energy technologies research report of Taiwan in 2007” written by Taiwan Ocean Technologies Research Center and published by Energy Department of Taiwan's Economic Ministry in December 2007, sites having fluid velocity of 1.2 m/s, distance from coastline greater than 20 km, and the depth of the sea greater than 100 m are appropriate for the installation of tidal stream generators. Thus, only sea off the eastern coast of Taiwan is appropriate for the site selection. It is particularly important that it is not economic if the site on the sea has a fluid velocity less than 1.2 m/s.

It is thus desirable to develop an electric turbine generator capable of generating electricity economically when it is installed on the sea having ocean current greater than 0.3 m/s, a distance from the site to coastline greater than 1 km, and the depth of the sea at the site is greater than 60 m.

### SUMMARY OF THE INVENTION

It is therefore one object of the invention to provide an electric turbine generator comprising a fluid confluent guide device including a housing and a plurality of guiding plates in the housing wherein the housing includes an inlet at a first end, a curved member at a second end, and a transverse channel as an outlet; and a wheel including two spaced rims and a plurality of blades annularly equally spaced apart with the outlet disposed therein; wherein the blades and the outlet are concentric and each rim includes a plurality of teeth.

The invention has the following advantages and benefits in comparison with the conventional art:

Fluid does not strike the blades due to the provision of the fluid confluent guide device. Instead, the fluid is guided by the fluid confluent guide device prior to hitting the blades for rotation. The fluid confluent guide device not only increases the flow velocity but also converts the energy of flowing water into useful forms of power.

The wheel without axle may rotate freely in a confined space. The wheel may have one of a plurality of different designs with a fluid striking area of the blade greatly increased, a diameter of the wheel greatly increased, and number of the blades increased greatly. Great electric energy is generated by the wheel even when the fluid velocity is low. Electricity generation performance is greatly improved.

The plural the electricity generating devices are driven by the wheel. Total electricity generation is borne by the plurality of electricity generating devices. Each of single electricity generating device has a relatively small weight. This can lower the risk of installing or detaching the electricity generating device. Further, the electric turbine generator can be installed above the sea level to prevent the electricity generating devices from being immersed in sea water.

Thus, the first aspect of the present invention is an electric turbine generator comprising a fluid confluent guide device including a housing and a plurality of guiding plates in the housing wherein the housing includes an inlet at a first end, a curved member at a second end, and a transverse channel of the curved member of two side has a fluid outlet; and a wheel including two spaced rims on the two sides of the curved member and a plurality of blades annually disposed between the rims and equally spaced apart with the fluid outlet disposed therein; wherein the plurality of blades are arranged in a radial circular array with respect to each other in an angular relationship and concentrically arranged with the fluid outlet and each rim includes a plurality of gears.

According to an embodiment of the present invention, the guiding plates are annularly, equally spaced apart in a relationship with each other in the housing, each guiding plate has two ends secured to two opposite surfaces of the housing respectively, and all of them are concentrically arranged with the fluid outlet of the fluid confluent guide device, and fluid entering a space between the two adjacent guiding plates is divided into a plurality of single rotating fluid portions.

According to an embodiment of the present invention, a cross sectional area of the inlet of the fluid confluent guide device is greater than that of the outlet thereof.

According to an embodiment of the present invention, the wheel is without an axle.

According to an embodiment of the present invention, further comprising a plurality of positioning members secured to two opposite surfaces of the curved member of the housing respectively wherein the rims of the wheel are configured to rotationally move relative to the positioning members, each positioning member includes a wheel and an axle disposed through a center of the wheel, and the axle is secured to either surface of the curved member of the housing.

According to an embodiment of the present invention, further comprising a plurality of positioning members secured to two opposite surfaces of the curved member of the housing respectively wherein the rims of the wheel are configured to rotationally move relative to the positioning members, each positioning member includes a wheel and an axle disposed through a center of the wheel, and the axle is secured to either surface of the curved member of the housing.

According to an embodiment of the present invention, further comprising a plurality of positioning members secured to two opposite surfaces of the curved member of the housing respectively wherein the rims of the wheel are configured to rotationally move relative to the positioning members, each positioning member includes a short-arm plate and a long-arm plate, the short-arm plate is secured to either surface of the curved member of the housing, one end of the long-arm plate is formed with the short-arm plate and distal the surface of the housing, and the rims of the wheel are configured to rotate within the long-arm plates positioningly.

According to an embodiment of the present invention, further comprising a plurality of positioning members secured to two opposite surfaces of the curved member of the housing respectively wherein the rims of the wheel are configured to rotationally move relative to the positioning members, each positioning member includes a short-arm plate and a long-arm plate, the short-arm plate is secured to either surface of the curved member of the housing, one end of the long-arm plate is formed with the short-arm plate and distal the surface of the housing, and the rims of the wheel are configured to rotate within the long-arm plates positioningly.

According to an embodiment of the present invention, further comprising a plurality of electricity generating devices each including a gear and an electric generator disposed externally of the curved member of the housing wherein the gear is positioned on a shaft of the electric generator, and the gear meshes with a plurality of gears of each rim.

According to an embodiment of the present invention, the gear of each of the electricity generating devices is replaced by a transmission gearbox.

According to an embodiment of the present invention, a total electricity generation is borne by the plurality of electricity generating devices.

The above and other objects, features and advantages of the invention will become apparent from the following detailed description taken with the accompanying drawings.

### BRIEF DESCRIPTION OF THE DRAWINGS

FIG. 1 is a perspective view of an electric turbine generator according to the invention;

FIG. 2 is a perspective view of the fluid confluent guide device;

FIG. 3 is a side elevation of the fluid confluent guide device showing fluid flow directions;

FIG. 4 is a perspective view of the wheel and the positioning members;

FIG. 5 schematically depicts locations of the guiding plates and the blades;

FIG. 5A is a detailed view of the area A in FIG. 5;

FIG. 6 is a view similar to FIG. 5 showing fluid flow;

FIG. 6A is a detailed view of the area A in FIG. 6;

FIG. 7 a perspective view of the wheel, the positioning members and the electricity generating devices;

FIG. 7A is a detailed view of the area A in FIG. 7;

FIG. 7B is a side elevation in part section of FIG. 7A;

FIG. 8 is a side elevation of FIG. 7;

FIG. 9 is a perspective view of the electric turbine generator secured to the sea bottom;

FIG. 9A is a detailed view of the area B in FIG. 9 showing the electricity generating device;

FIG. 10 is a side elevation of FIG. 9;

FIG. 11 is a perspective view of the wheel showing a second embodiment of the positioning members; and

FIG. 12 is a perspective view of the fluid confluent guide device incorporating the wheel and the second embodiment of the positioning members.

### DETAILED DESCRIPTION OF THE INVENTION

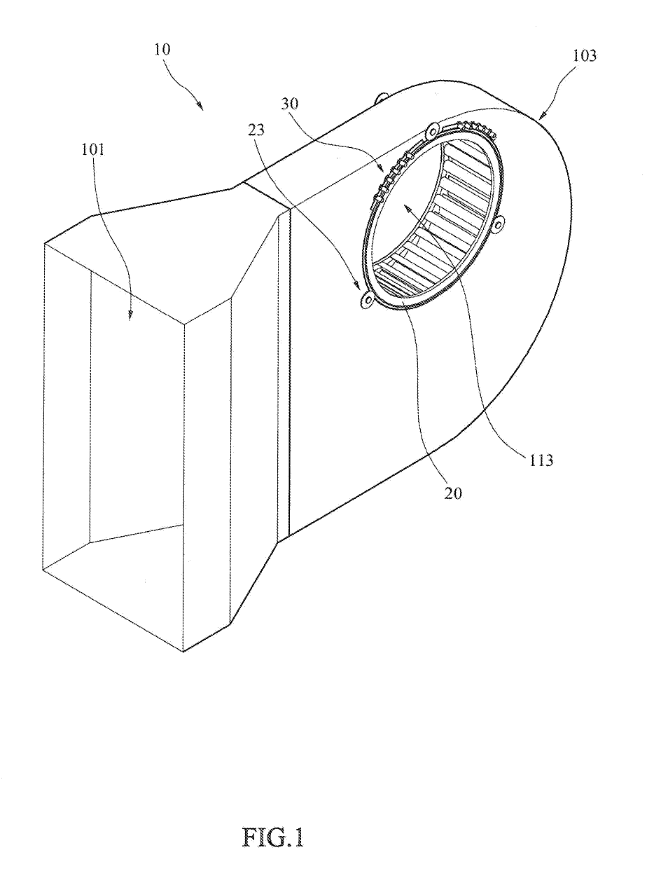

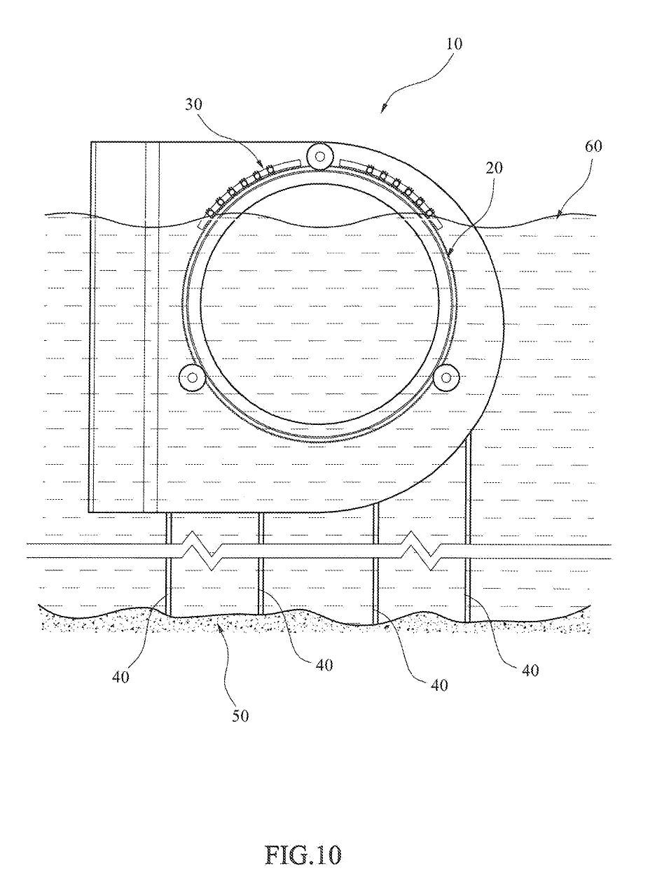

Referring to FIGS. 1 to 10, an electric turbine generator in accordance with the invention comprises a fluid confluent guide device 10, a wheel 20, a plurality of fastening devices 23, a plurality of electricity generating devices 30, and a plurality of supports 40. The supports 40 are shown in a reduced height for the purpose of description.

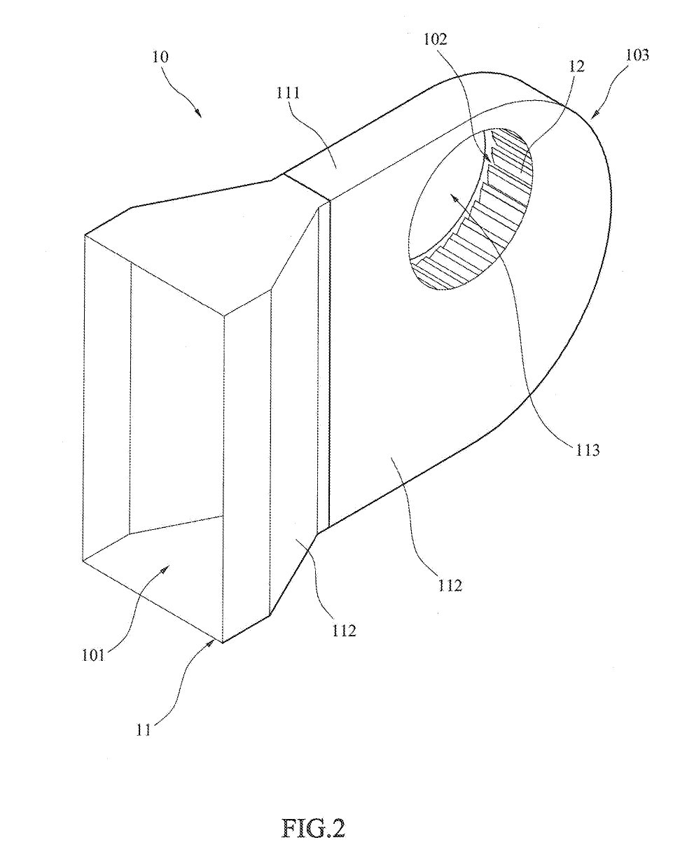

As shown in FIG. 2 with both the wheel 20 and the positioning devices 23 omitted, the fluid confluent guide device 10 includes a housing 11 and a plurality of guiding plates 12 arranged as a circle. The housing 11 includes an enclosure 111 and a hood 112. The hood 112 includes an inlet 101. The enclosure 111 includes a curved member 103 and a transverse channel 113 with the guiding plates 12 provided therearound. Both ends of each guiding plate 12 are secured to two inner surfaces of the enclosure 111 respectively. An outlet member 122 is provided between any two adjacent guiding plates 12. The outlet members 122 together serve as an outlet 102 of the fluid confluent guide device 10.

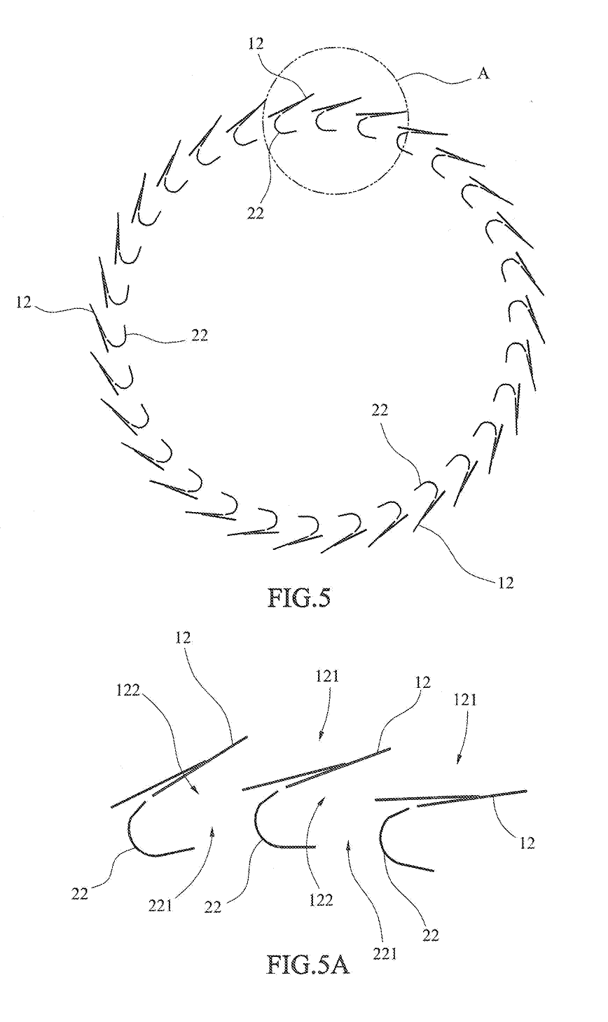

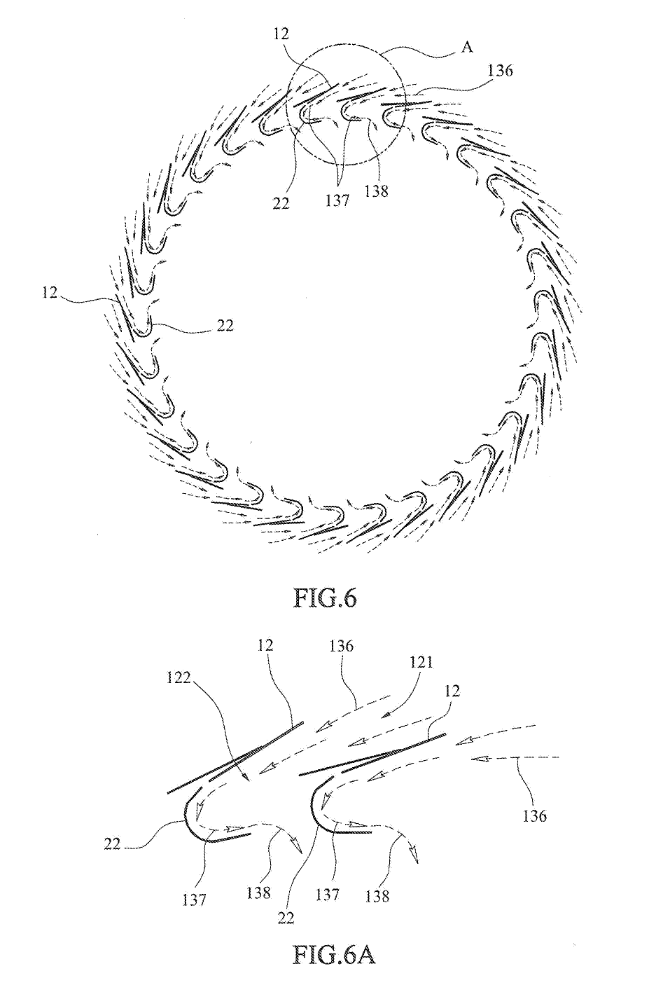

As shown in FIGS. 5A and 6A, fluid entering an inlet member 121 between the two adjacent guiding plates 12 is divided into a plurality of rotating fluid portions each exiting an outlet member 122 between the adjacent guiding plates 12 to rotate one of a plurality of blades 22 of the wheel 20. A cross sectional area of the inlet 101 of the fluid confluent guide device 10 is greater than that of the outlet 102. Thus, fluid flow velocity is increased at the outlet 102.

One characteristic of the invention is detailed below. The plurality of rotating fluid portions of the fluid each strike the blade 22 to rotate the wheel 20 in an optimum angle so as to convert the energy of flowing water into useful forms of power.

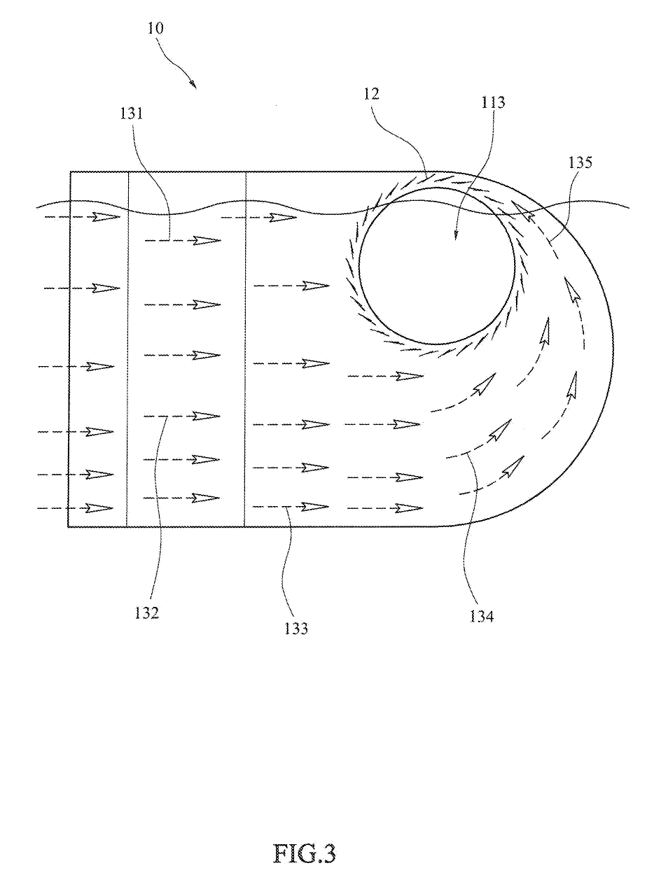

Referring to FIG. 3, flow paths and operation principles are described below. First fluid portion 131, a second fluid portion 132 and a third fluid portion 133 flow from the inlet 101 into the fluid confluent guide device 10 to initially converge into a fourth fluid portion 134. And in turn, the fourth fluid portion 134 guided by the curved member 103 of the housing 11 to further converge into a fifth fluid portion 135. Another portion of the fluid flow enters the inlet members 121 each between the guiding plates 12.

As shown in FIGS. 5, 6 and 6A, a sixth fluid portion 136 is formed between two adjacent guiding plates 12 at the beginning of fluid division. The sixth fluid portions 136, as a result of dividing the fluid into a plurality of rotating fluid portions, further merge into a seventh fluid portion 137 which act on the blade 22 for rotating the wheel 20 in an optimum angle so as to convert the energy of flowing water into useful forms of power (e.g., rotational mechanical energy). Further, energy of the seventh fluid portion 137 is transferred to the blade 22 when it flows along the curved surface of the blade 22. Furthermore, an eighth fluid portion 138 is formed when the fluid leaves a blade outlet 221. Finally, the fluid leaves the fluid confluent guide device 10 via the channel 113.

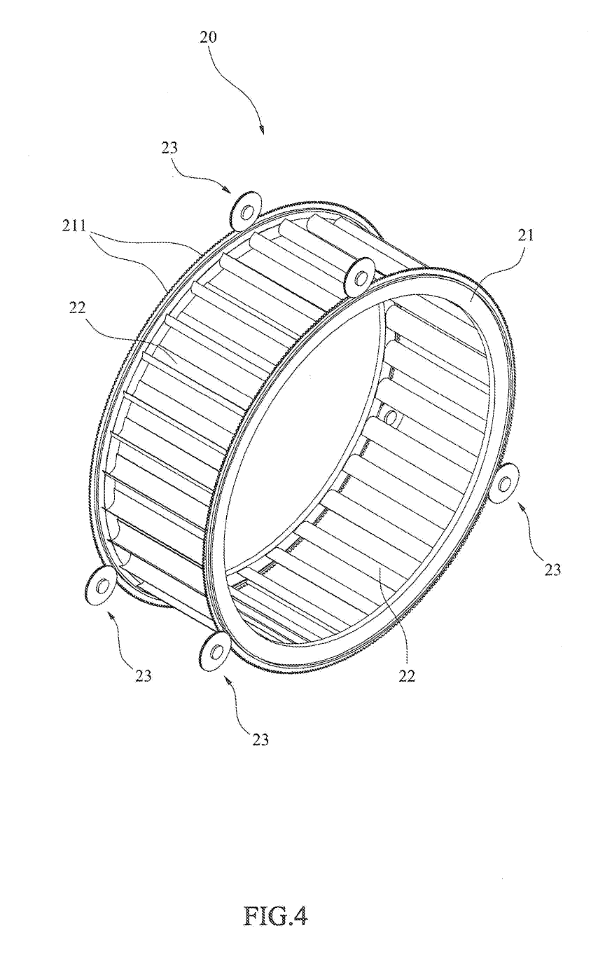

As shown in FIG. 4, the wheel 20 does not have an axle and includes two spaced rims 21, a plurality of blades 22 between the rims 21, and a plurality of positioning members 23. The blades 22 are equally spaced apart along a virtual circle with the channel 113 disposed therein. The rim 21 includes a plurality of teeth 211. The positioning members 23 are secured to two opposite surfaces of the housing 11 respectively. The rim 21 may have some degree of positioning and floating and rotationally move relative to or within the positioning member 23. The positioning member 23 includes a wheel 231 and an axle 232.

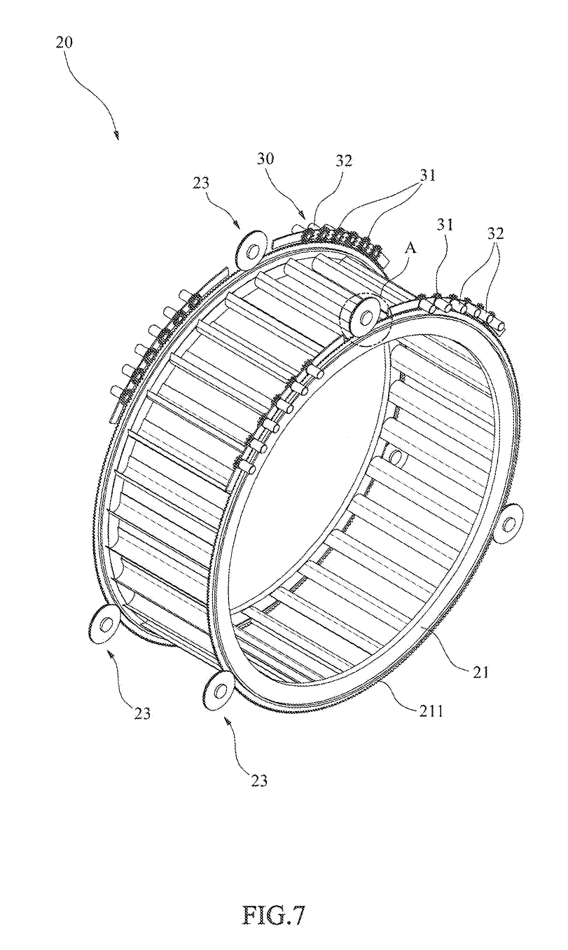

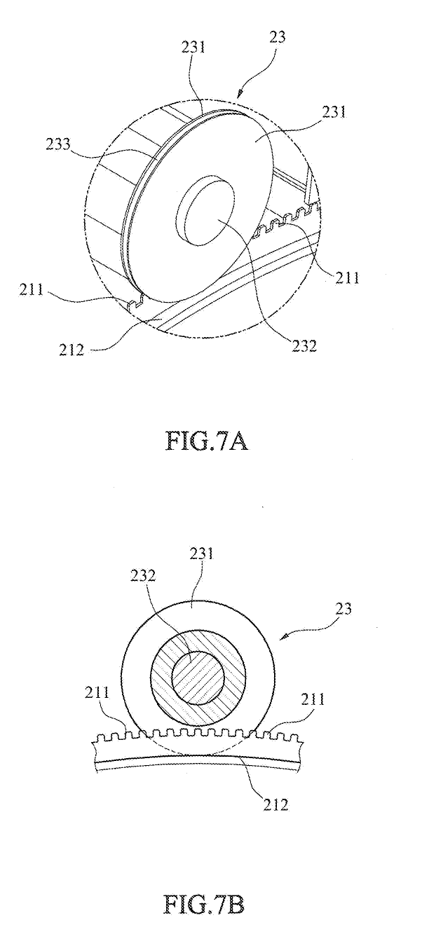

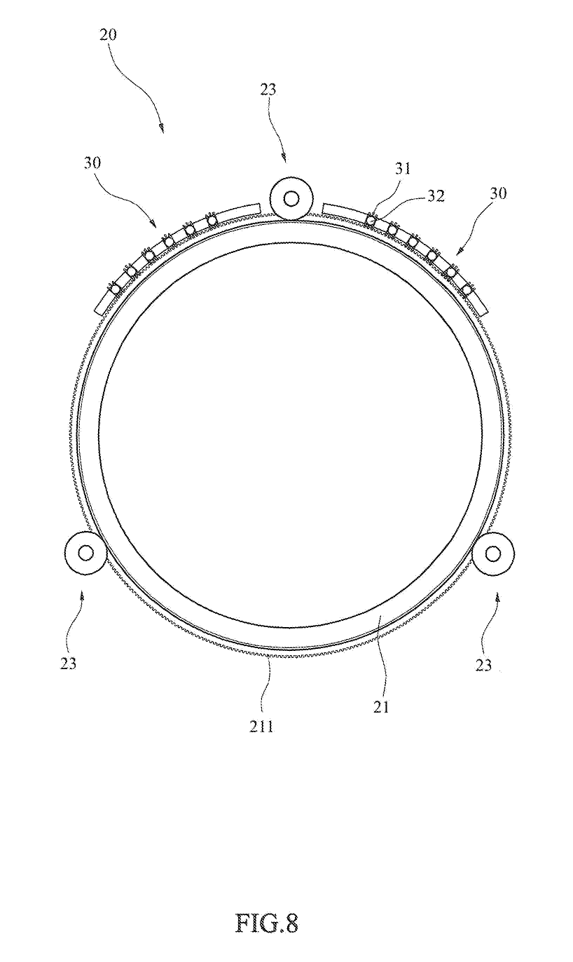

As shown in FIGS. 7, 7A and 7B, the axle 232 is disposed through a center of the wheel 231. The axle 232 is secured to either surface of the curved member 103 of the housing 11. As mentioned above the rims 21 may rotationally move relative to or within the positioning members 23. As shown in FIGS. 7, 7A, 7B and 8, in response to flowing fluid to the blades 22, the wheel 20 without axle may rotate freely, normally in a confined space, i.e. within the positioning members 23.

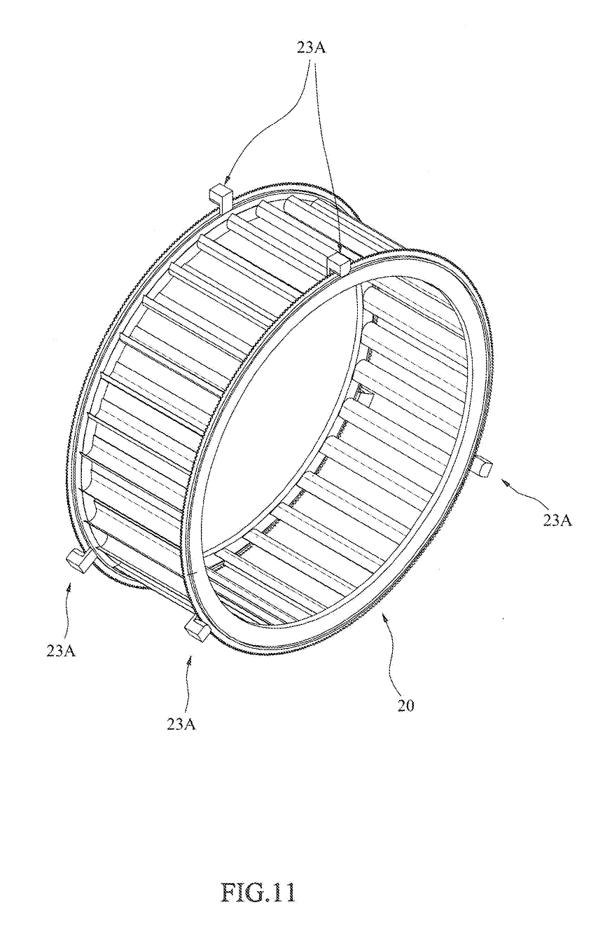

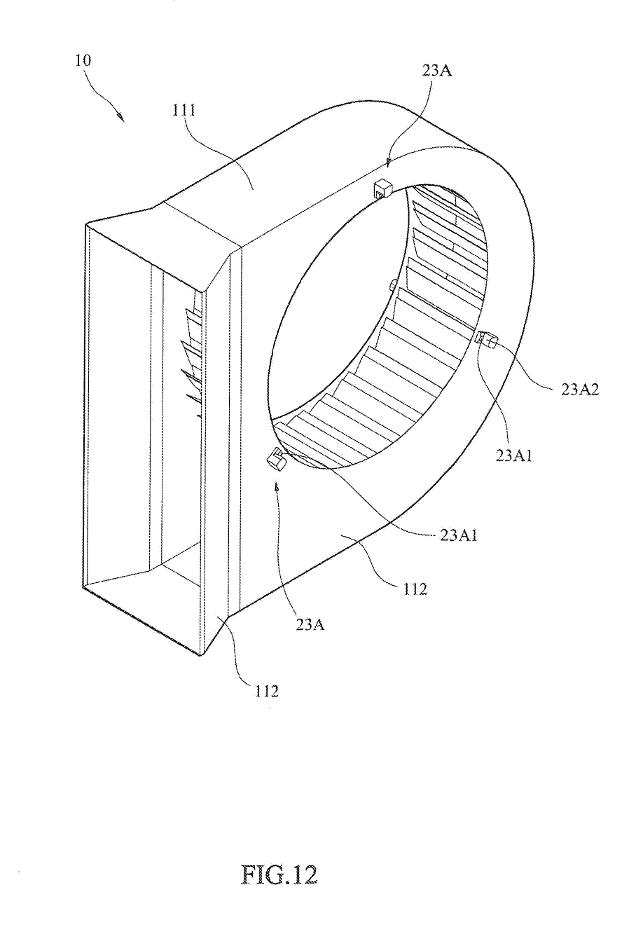

Referring to FIGS. 11 and 12, a second embodiment of positioning members 23A of the invention is shown. The positioning members 23A are adapted to rotate about the rims 21. The positioning member 23A includes a first plate 23A1 and a second plate 23A2. The first plate 23A1 is secured to either surface of a curved portion of the housing 11. The positioning members 23A are equally spaced apart along a virtual circle. One end of the second plate 23A2 is formed with the first plate 23A1 and distal the surface of the housing 11. The rims 21 are adapted to rotate within a confined space of the second plates 23A2, as mentioned above.

Therefore, the wheel 20 without axle may rotate freely, normally in a confined space. The wheel 20 may have one of a plurality of different designs with a fluid striking area of the blade 22 greatly increased, a diameter of the wheel 20 greatly increased, and the number of the blades 22 increased greatly. Thus, great electric energy is generated by the wheel 20 even when the fluid velocity is low. As a result, electricity generation performance is greatly improved and this is the main object of the invention.

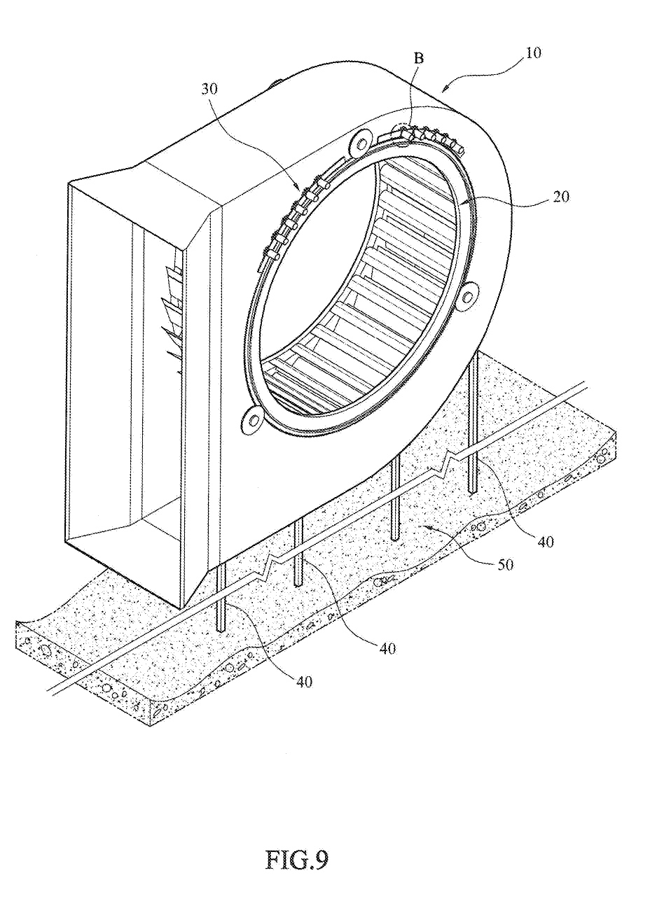

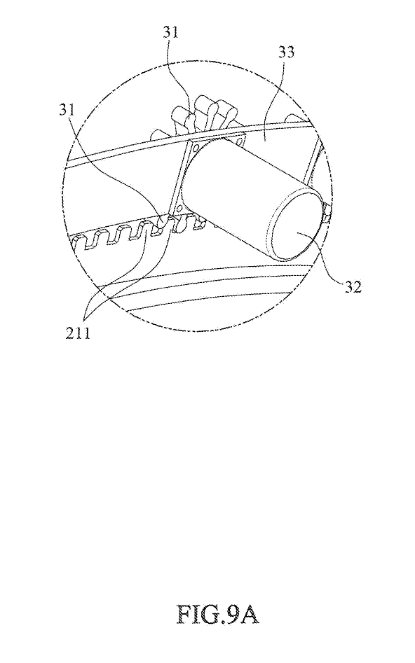

Each of the plurality of electricity generating devices 30 includes a gear 31 and an electric generator 32 disposed externally of the housing 11. The gear 31 is positioned on a shaft of the electric generator 32. The gear 31 meshes with gears 211 of the rim 21 (see FIGS. 1 and 9A). The electricity generating devices 30 may generate electricity in response to rotating the wheel 20. Thus, the potential energy of the fluid can be converted into electrical energy. The electricity generating devices 30 are driven by the wheel 20. Total electricity generation is borne by the plurality of electricity generating devices 30. Thus, a single electricity generating device 30 has a relatively small weight. This has the benefits of lowering the risk of installing or detaching the electricity generating device 30. Further, the electric turbine generator of the invention can be installed above the sea level 60. This also has the benefit of preventing the electricity generating devices 30 from being immersed in sea water. As a result, the useful life of the electric turbine generator is greatly prolonged. The gear 31 of the electricity generating device 30 can be replaced by a manual transmission secured to the two opposite surfaces of the curved portion of the housing 11. Further, the transmission gearbox meshes with the teeth 211 of the rims 21.

It will be further understood that the above-mentioned electric turbine generator may be capable of converting the energy of flowing water (e.g., sea water) and also wind into useful forms of power.

The plurality of the supports 40 are used to secure the electric turbine generator of the invention by fastening on the sea bottom 50. Further, the bottom of the housing 11 is supported by the supports 40. As a result, the electric turbine generator of the invention is secured.

While the invention has been described in terms of preferred embodiments, those skilled in the art will recognize that the invention can be practiced with modifications within the spirit and scope of the appended claims.

What is claimed is:

1. An electric turbine generator comprising:
a fluid confluent guide device including a housing and a plurality of guiding plates in the housing wherein the housing includes an inlet at a first end, a curved member at a second end, and a transverse channel of the curved member of two side has a fluid outlet; and
a wheel including two spaced rims on the two sides of the curved member and a plurality of blades annually disposed between the rims and equally spaced apart with the fluid outlet disposed therein;
wherein the plurality of blades are arranged in a radial circular array with respect to each other in an angular relationship and concentrically arranged with the fluid outlet and each rim includes a plurality of gears.

2. The electric turbine generator of claim 1, wherein the guiding plates are annularly, equally spaced apart in a relationship with each other in the housing, each guiding plate has two ends secured to two opposite surfaces of the housing respectively, and all of them are concentrically arranged with the fluid outlet of the fluid confluent guide device, and fluid entering a space between the two adjacent guiding plates is divided into a plurality of single rotating fluid portions.

3. The electric turbine generator of claim 1, wherein a cross sectional area of the inlet of the fluid confluent guide device is greater than that of the outlet thereof.

4. The electric turbine generator of claim 1, wherein the wheel is without an axle.

5. The electric turbine generator of claim 1, further comprising a plurality of positioning members secured to two opposite surfaces of the curved member of the housing respectively wherein the rims of the wheel are configured to rotationally move relative to the positioning members, each positioning member includes a wheel and an axle disposed through a center of the wheel, and the axle is secured to either surface of the curved member of the housing.

6. The electric turbine generator of claim 4, further comprising a plurality of positioning members secured to two opposite surfaces of the curved member of the housing respectively wherein the rims of the wheel are configured to rotationally move relative to the positioning members, each positioning member includes a wheel and an axle disposed through a center of the wheel, and the axle is secured to either surface of the curved member of the housing.

7. The electric turbine generator of claim 1, further comprising a plurality of positioning members secured to two opposite surfaces of the curved member of the housing respectively wherein the rims of the wheel are configured to rotationally move relative to the positioning members, each positioning member includes a short-arm plate and a long-arm plate, the short-arm plate is secured to either surface of the curved member of the housing, one end of the long-arm plate is formed with the short-arm plate and distal the surface of the housing, and the rims of the wheel are configured to rotate within the long-arm plates positioningly.

8. The electric turbine generator of claim 4, further comprising a plurality of positioning members secured to two opposite surfaces of the curved member of the housing respectively wherein the rims of the wheel are configured to rotationally move relative to the positioning members, each positioning member includes a short-arm plate and a long-arm plate, the short-arm plate is secured to either surface of the curved member of the housing, one end of the long-arm plate is formed with the short-arm plate and distal the surface of the housing, and the rims of the wheel are configured to rotate within the long-arm plates positioningly.

9. The electric turbine generator of claim 1, further comprising a plurality of electricity generating devices each including a gear and an electric generator disposed externally of the curved member of the housing wherein the gear is positioned on a shaft of the electric generator, and the gear meshes with a plurality of gears of each rim.

10. The electric turbine generator of claim 9, wherein the gear of each of the electricity generating devices is replaced by a transmission gearbox.

11. The electric turbine generator of claim 1, wherein a total electricity generation is borne by the plurality of electricity generating devices.
